(19) United States
(12) Patent Application Publication
(10) Pub. No.: US 2021/0004911 A1
(43) Pub. Date: Jan. 7, 2021

(54) SENSOR-BASED MONITORING SYSTEM

(71) Applicant: Modifi, Inc., Seattle, WA (US)

(72) Inventors: James A. Poss, Bainbridge Island, WA (US); Ashish Shah, Woodinville, WA (US)

(21) Appl. No.: 16/919,662

(22) Filed: Jul. 2, 2020

Related U.S. Application Data
(60) Provisional application No. 62/870,875, filed on Jul. 5, 2019.

(51) Int. Cl. G06Q 40/08; G01D 21/02

(52) U.S. Cl. CPC G06Q 40/08; G01D 21/02

(57) ABSTRACT

The disclosed system may be used measure human workplace activity using a combination of sensor data and input from the worker himself or herself. A device carried by the worker is configured to guide the worker through a particular task or job, and to track the worker's progress as the job is completed. The data collected by the device can be analyzed to assess and enhance the efficiency at which the particular work can be done. The disclosed system can also be used to determine a level of risk associated with various human activities and calculate the cost of workers' compensation insurance and other types of insurance based on the measured activities. The risk and cost of various activities can be measured and adjusted to make people safer and less costly to insure.

### BACKGROUND

The present invention relates to human behavior data acquisition and processing systems, and particularly to a system for monitoring people in hazardous work tasks for the purpose of determining a more accurate determination of the cost of insurance for the person. The system is a unique composition of sensor inputs and human inputs which results in a learning system to characterize and categorize work activities on a granular and dynamic basis.

### SUMMARY

The present invention relates to a device, system and method for measuring human workplace activity, using a combination of sensor data and input from the worker himself or herself. In an illustrative embodiment, the sensors are embedded in smartphone, smartwatch or similar device carried by the worker. The device is configured to guide the worker through a particular task or job, and to track the worker's progress as the job is completed. The data collected by the device can be analyzed to assess and enhance the efficiency at which the particular work can be done. Another exemplary application of the inventive system is to calculate insurance rates for workers' compensation insurance, life insurance, professional liability insurance or other forms of insurance related to covering a person engaged in activities that have variable associated risk, liability and cost.

In an illustrative embodiment, the inventive system comprises a plurality of sensors embedded in a smartphone. The sensors may include, e.g., an accelerometer, barometer, gyroscope, microphone, GPS receiver, ambient light sensor, proximity sensor, magnetometer, touchscreen, fingerprint sensor, pedometer, heart rate sensor, thermometer, humidity sensor, Geiger counter, etc. Alternative, the sensors could be embedded in other devices, such as a watch, lanyard, body-camera, safety harness or hard hat.

The sensors detect motions, sounds associated with different types of activities. The system can also include a machine learning system so that a library of sensor patterns can be matched to each activity. With each new task logged, the system learns, thus it is a machine learning system and method.

The inventive system also incorporates human inputs, such as the two-way communication of work orders, instructions, schedules, dates, user responses to surveys, and safety training data communication. These inputs are paired with sensor data as a supplement a machine learning-training system to inform the conclusions reached about certain activities. Additional features are described below.

### BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a diagram of a sensor device according to one embodiment.

FIG. 2 is a diagram of a sensor device that includes a computer, according to one embodiment.

FIG. 3 is a diagram of a sensor system according to one embodiment.

FIG. 4 is a diagram of a sensor system according to another embodiment.

FIG. 5 is a rule matrix according to one embodiment.

FIG. 6 is a schematic diagram of a user-interface on a smartphone or tablet that shows how the user may enter activity data according to one embodiment.

FIG. 7 is a schematic diagram of a user-interface on a smartphone or tablet or desktop computer or laptop showing how a user may review summary calculated data submitted by another user according to one embodiment.

FIG. 8 is a schematic diagram of a user-interface on a smartphone or tablet or desktop computer or laptop showing how a user may review additional summary calculated data submitted by another user according to one embodiment.

### DETAILED DESCRIPTION OF ILLUSTRATIVE EMBODIMENTS

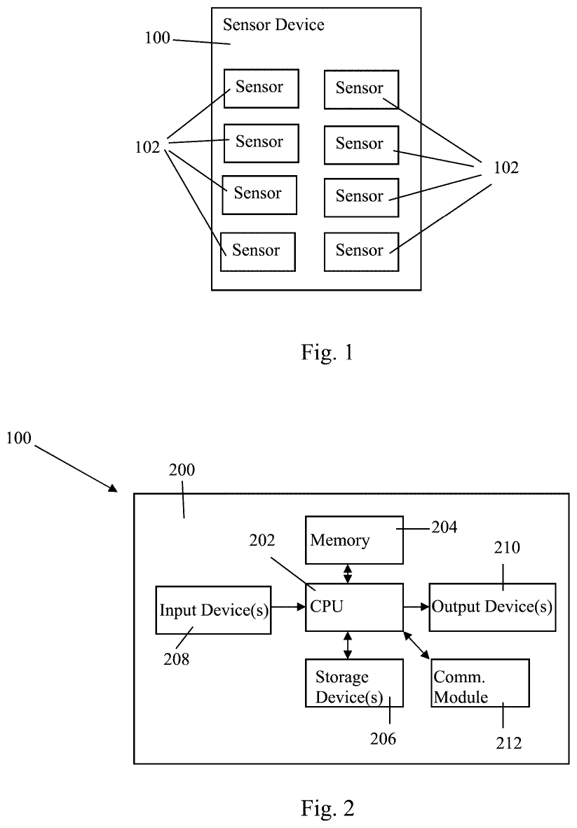

Referring now to the drawings wherein the showings are for purposes of illustrating embodiments of the invention only and not for purposes of limiting the same, and wherein like reference numerals are understood to refer to like components, FIG. 1 shows one simplified diagram of a sensor device 100, according to one embodiment, having a plurality (i.e., at least one) of individual sensors 102. In another embodiment, a sensor device 100 may have one sensor 102.

A sensor 102 may sense at least one variable and output data correlated to the at least one sensed variable. Various embodiments of sensors 102 may include: an accelerometer, a magnetometer, a global positioning system (GPS) sensor, a light meter, a microphone, barometer, a camera, a thermometer, a power sensor and a user-interface, which may have a “digitizer” to sense inputs from the user. Sensors 102 may sense sound, movement, speed, acceleration, proximity, altitude, barometric pressure, light, location, orientation, magnetic fields, temperature, the absence or presence of power, or sensed feedback from the user acting on the user-interface. Alternative embodiments of the sensor device 100 may include different numbers of sensors 102, where each sensor 102 may sense a different variable from each other sensor 102, the same variable as at least one other sensor 102, or the same variable as all the other sensors 102.

FIG. 2 shows another diagram of a sensor device 100 that includes a specially-programmed computer 200, according to one embodiment. The computer 200 may include a central processing unit (CPU) 202 that may execute the programmed code for implementing the sensor system discussed further below and which may include external processing and data storage devices. The computer 200 may also include at least one input device 208 to allow a user to control the computer 200 and provide input to the computer 200. An input device 208 may include, but is not limited to, a touch screen, a keyboard or keypad, a mouse, a touchpad, a track-stick, a microphone and speaker, and a sensor 102.

The computer 200 may also include memory 204 for temporarily storing program code and gathered data during execution. The CPU 202 may write data to the memory 204 and may read data from the memory 204. The computer 200 may include at least one output device 210, which may include, but is not limited to, a display or monitor, a printer, a projector, and a speaker. The computer 200 may include a communication module or interface 212 that allows the computer 200 to communicate with other computers, which may be through a network. The communication discussed in this specification may be wired or wireless. In alternative embodiments, the communication may be by local area network (LAN), wide area network (WAN), the wireless local area networking protocol used by devices certified under the certification mark WI-FI®, the telecommunication and computer protocol used by devices certified under the certification mark BLUETOOTH®, infrared, radiofrequency (RF), a cellular network, TDMA, CDMA, FDMA, the communication protocol used by devices sold under the trademark GSM®, near-field communication (NFC) or fiberoptic. The computer 200 may also include at least one storage device 206, which may be used for storing the program code, user-entered data, and processed and saved data. The storage device 206 may include, but is not limited to, a hard disk drive, a solid-state drive, and an optical disk drive. The processer may include configurations to delete certain data, or communicate certain data, based on pre-determined thresholds or a learning system that adapts to dynamic circumstances.

In one embodiment, at least one input device 208, the CPU 202, the memory 204, at least one output device 210, a storage device 206, and a communication module 212 may be housed in one enclosure. Examples may include a tablet, a laptop computer, a portable media device, or a mobile phone. In one embodiment, the sensor device 100 may be a smart mobile phone. In another embodiment, the input devices 208 and the output devices 210 may be housed separately from the memory 204, CPU 202, storage device 206, and communication module 212. An example may include a desktop computer. In another embodiment, the storage device 206 may be housed at a location remote from the other components of the computer 200 and may be accessed through the communication module 212. An example may include cloud storage. In alternative embodiments, the sensor device 100 may be portable or stationary. In another embodiment, the computer 200 may include a microcontroller that replaces the CPU 202 and that may replace the memory 204. In some embodiments, a sensor device 100 may include sensors 102, processing capability, and communication capability.

In another embodiment, a sensor device 100 may include a sensor 102 but not a computer 200. Where a sensor device 100 does not include a computer 200, the sensor device 100 may communicate with, and send sensed data to, an external computer 200. The sensor device 100 may also send a signal proportional to the sensed variable to an external device (which may be a computer 200) for processing. In one embodiment, the sent proportional signal may be an analog signal that is processed by the external device into digital data. The below discussion refers to a sensor device 100 that includes a computer 200, but the discussion may also apply analogously to a sensor device 100 without a computer 200 but connected to an external computer 200.

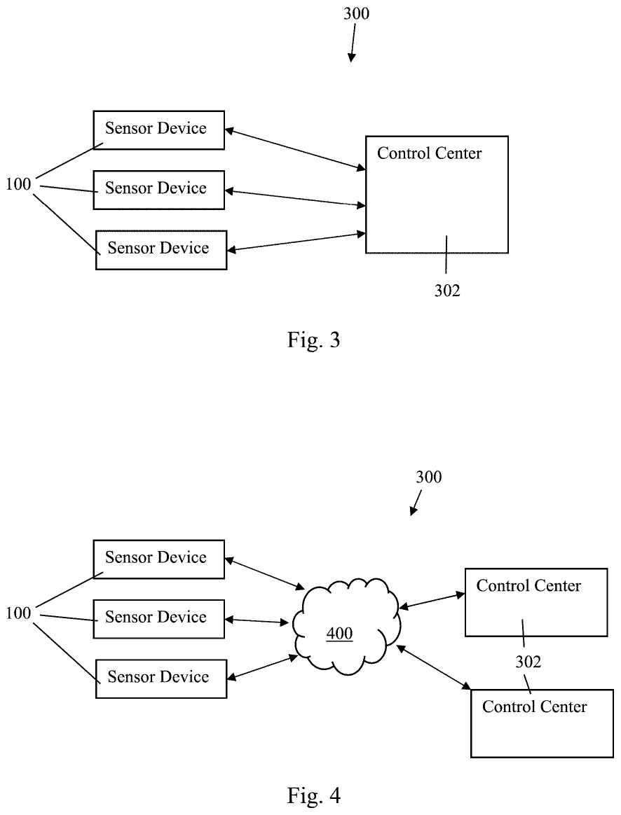

FIG. 3 shows a diagram of a sensor system 300 according to one embodiment. A sensor system 300 may include at least one sensor device 100 and at least one control center 302. The control center 302 may also include a computer 200. The sensor device(s) 100 may communicate with the control center(s) 302 directly or indirectly, e.g., through an access point, gateway, or router. In one embodiment, the gateway may be an IoT gateway with MQTT topics.

FIG. 4 shows a diagram of a sensor system 300 according to another embodiment. The sensor system 300 shown in FIG. 4 is similar to the sensor system 300 shown in FIG. 3, except that the sensor devices 100 and control centers 302 may communicate through the cloud 400 or Internet. With continued reference to FIGS. 3-4, the sensor devices 100 may also communicate with other sensor devices 100, whether directly or indirectly. The control centers 302 may also communicate with other control centers 302, whether directly or indirectly. In some embodiments, the communication between sensor devices 100 or within a sensor system 300 may be secured or encrypted, which may include private key encryption. In one embodiment, a user may remotely tap into any sensor device 100 to obtain its real-time or near-real-time sensed data. In one embodiment, the sensor system 300 may include an Internet of Things (IoT) system. In this and other embodiments, the sensor system 300 may be a sensor in a bucket truck, a ladder, in the gloves or vest of a worker or other devices. A sensor in a bucket truck may include sensing of the presence of a worker or the location and height of the bucket and personnel. The sensor data may be combined with other data, such as the type of location. In this embodiment, the system is configured to calculate the level of risk associated with the operation of a bucket truck, the height of the worker, the level of traffic and speed of traffic on the street, so as to determine the level of risk associated with the operation of the bucket truck on a particular day, at a particular time, on a particular road. This is geared to gauge the level of risk at one jobsite versus another.

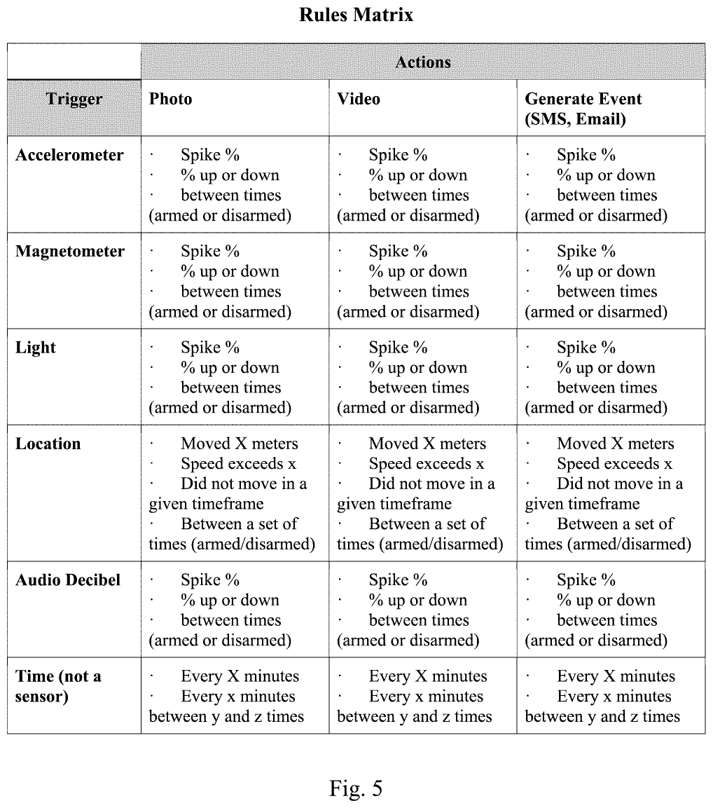

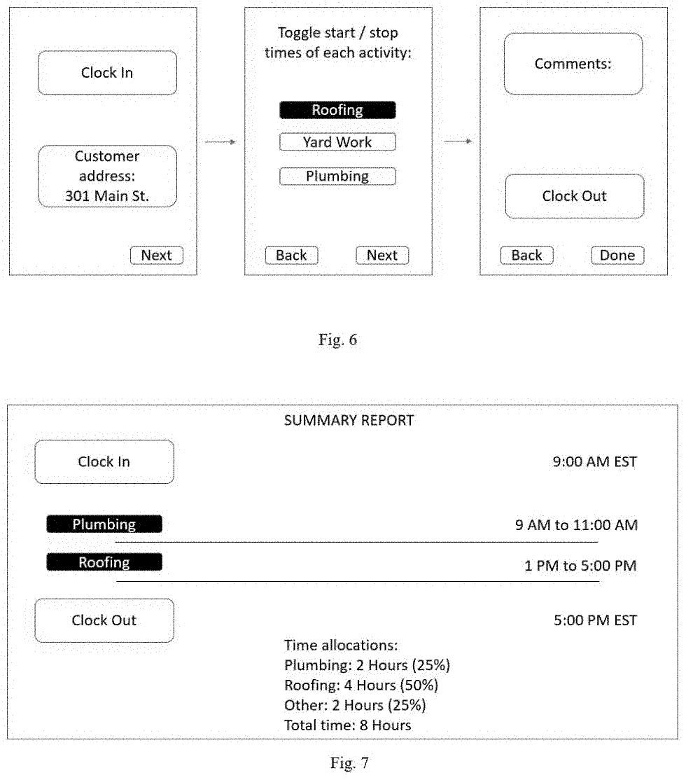

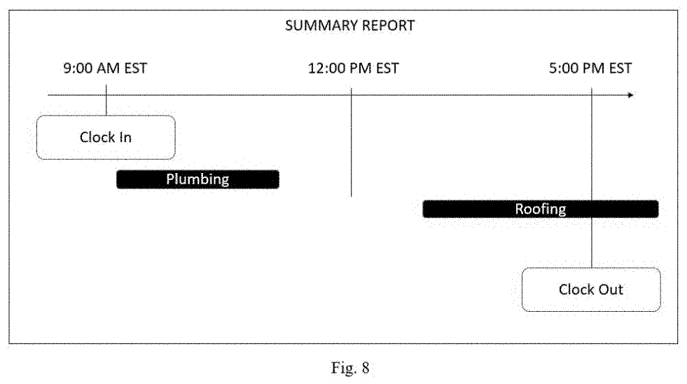

With continued reference to FIGS. 3-4, a user may program the sensor device 100 or sensor system 300 to perform an action when a trigger is activated. This may be known as a rule: if a defined triggering variable meets a defined condition, then perform a defined action. In alternative embodiments, a user may program or control a sensor device 100 using the sensor device 100 itself, through a control center 302 in communication with the sensor device 100, or through another sensor device 100 in communication with the sensor device 100 being programmed or controlled. The control center 302 and/or sensor device 100 may include an application to facilitate such programming or control. The application may show the settings in effect, any data or summaries of data, new updates, and communications. The application may show or allow customization of a rule matrix. An example of a rule matrix is shown in FIG. 5. In one embodiment, the application may be a web portal. A control center 302 may include an application that allows defining users, organizations, and settings of a sensor system 300.

The control center 302 may save data, including sensor data, received from the sensor devices 100, whether locally or remotely (including in the cloud 400). In one embodiment, a control center 302 may store data in a relational database, including in an RDS instance. In alternative embodiments, a control center 302 may be a client or a server. A sensor device 100 may store data locally until communication with a sensor system 300 is available.

Actions that may be triggered include, in alternative embodiments: taking a photo; capturing video and/or audio; playing or transmitting a sound and/or video; showing or transmitting a photo; sending an email, text message, uploading accelerometer, barometer, or location data, or multimedia message (any of which may include sound, video, or photo); initiating a telephone or video conference call; and executing a command, script, or program. Triggered actions may also be known as alerts. For example, if it is sensed that a person has climbed a ladder, or is scheduled to climb a ladder, safety reminder procedures may be uploaded to the smartphone of the user in real time, and if the sensors indicate that the person has fallen off the ladder, an alert may be sent to medical personnel. Additionally, a message about a safety violation or incident may be reported to a third party, such as a general contractor or business owner, if an incident has been detected by a subcontractor or employee.

Triggering events may include, in alternative embodiments: any sensor 102 reaching a threshold (including an increase or decrease greater than or less than a certain percentage or value), the elapsing of a threshold amount of time, or external data meeting a preset condition. Further examples of triggering events include: detecting sounds (e.g., sound captured by a microphone reaching a certain decibel threshold or pitch, tone and frequency characteristic of a certain activity, or inputs into the user-interface), detecting movement (e.g., a change in a threshold number of pixels in an image captured by a camera, or GPS sensor location changing by a threshold amount), detecting light or darkness (e.g., lux level of an ambient light meter reaching a certain threshold), detecting location (e.g., GPS sensor location reaching certain coordinates), detecting orientation, detecting magnetic fields, detecting presence or absence of connected power (e.g., whether a sensor device 100 is operating on battery power or is connected to an external power supply), detecting battery level, and an Internet search frequency reaching a certain threshold. In alternative embodiments, sensor thresholds may be fixed or changeable, whether automatically based on an algorithm or manually by a user. A threshold that results in a sensor 102 triggering may be known as, or affect, the sensor's sensitivity. Triggering events may be thought of as 1) a trigger variable 2) reaching a condition. In alternative embodiments, the trigger value that is compared against a threshold may be a single value, may be an average of a defined number of values, or may be another statistical measure of a defined number of values. In alternate embodiments, trigger sensors may be made more accurate because sensor values are compared to a digital signature of a relevant event. A Bulldozer has a certain pitch, tone, decibel level and length, for example, and if a device is configured to sense Bulldozers, it is helpful to compare empirical sensor data to previously-measured sensor values which may constitute a digital signature. Likewise, there are patterns of other sounds, sights or sensor readings that can be characterized and identified so that they can be used as a trigger sensor. As described herein, many sensor readings mentioned may have digital or analog signatures of relevance, patterns, characteristics, such as the motion pattern of a person climbing a ladder, or operating a bucket truck, or the sound pattern of a machine or the sound of glass breaking. As described herein, some sensor readings are input by a user into the user-interface, and may result in a set of actions to be triggered, such as a pre-determined or calculated sequence of actions. Patterns and anomalies may be identified by matching the data to pre-recorded data. Relevant sensor patterns may be applied and compared and contrasted to previously-categorized sensor data to add relevance and meaning to sensor readings, thus making the device capable of being more accurate, providing more actionable data or more helpful actions that result from a configuration of the device that couples an action to an identified sensor pattern or anomaly.

In one embodiment, programmed reactions to stimuli may be altered by other data. By fusing sensor data to determine patterns and irregularities across many parameters, the user may be able to better assess the root cause for the problems. For example, if every bit of data is within a range except for one piece of data, the irregular data may be determined or recommended as the aberration and thus, root cause. In each instance, the device is configured to measure data from multiple sources, compare that data against historical or expected patterns, identify any aberrational data or data that trends against a pre-set expectation or pattern, and then suggest to the user that the outlier is the most likely root cause, or is at least statistically more likely than other factors to be correlated to the abnormality.

In a related embodiment, sensor data not only is compared against historical or expected results, but actions may be prioritized by comparing results to pre-recorded results. Because the device is configured to dynamically evaluate responses to sensor data and dynamically generate subsequent sensor configurations, the device is capable of continuously improving because of the cumulative benefit of additional data linking sensor inputs to outputs. For example, if most users indicate lethargy after lunch or at the end of a working shift, the device will ask more lethargic people to do safer work tasks. One important feature of this device is that it is generic in the sensors that can collect data. On the user interface, for example, the “buttons” (or checkboxes, gradients, drop-down menus, free text boxes, voice memos, videos, photos and the like, and user-defined, so that there are infinite definitions for sensors, thresholds, sensitivities, timing and the like. Whether a user is concerned about accomplishments, safety, movement, opinion, proximity, location, time, etc., the device is configured to mathematically correlate sensor inputs, and in response, adjust outputs in a dynamic way, such that there is a cumulative mathematical association made between dynamically-generated sensor inputs and outputs, which control a user-interface, sensor timing, sensor sensitivity, thresholds and the like, in order to repetitively improve the understanding of the mathematical relationship between inputs and outcomes.

In one embodiment, a sensor 102 may be actuated (to sense its variable) at a set time interval, where the set time interval may be fixed or changeable, whether automatically based on an algorithm or manually by a user. In one embodiment, a minimum and/or maximum sensing frequency may be set. In another embodiment, the triggering of one sensor 102 may actuate at least one other sensor 102. In another embodiment, a user may manually actuate a sensor 102. Sensor actuation may be programmed or controlled in a manner analogous to the programming or control of actions performed when triggered. Sensor actuation may also be known as a sensing pattern. In one embodiment, any sensor may be enabled or disabled, whether automatically based on an algorithm or manually.

In one embodiment, accelerometer data may be captured every second or even every millisecond over a period of the sensing interval. Accelerometer data may include X, Y, and Z axes, and the combined data (sqrt(x\hat{ }2+y\hat{ }2+z\hat{ }2)). Accelerometer data may be calibrated to exclude the g-forces of earth's gravity, which is assumed to be constant. In one embodiment, the accelerometer sensing frequency may increase or decrease whenever the moving average of the past set number readings (e.g., 5) increases or decreases, respectively. In one embodiment, the accelerometer sensing frequency may be increased or decreased based on received information about earthquakes or a sudden change in light or sound, present or forecast weather events, changes in the stock market, or other external variables. In one embodiment a default maximum sensing frequency may be set at 50 Hz and default minimum sensing frequency set at once per hour.

In one embodiment, sensed gyroscope data may include X, Y, and Z axes, and the combined data (sqrt(x\hat{ }2+y\hat{ }2+z\hat{ }2)). In one embodiment, sensed location data may include latitude, longitude, and speed. In one embodiment, the significant digits of the sensed location data may be adjustable. In one embodiment sensed ambient light data may include lux levels. In one embodiment, sensed microphone data may include decibel levels. In one embodiment, a camera sensor 102 may be triggered to capture video or audio when the accelerometer 102 or magnetometer 102 senses a change, or when the camera sensor and processor detect a significant change in image. In this embodiment, it may be configured to detect specific images of relevance, such as the presence or absence of a person or thing, and a change in image (pixels) may trigger another action, such as an alert. For example, a camera sensor may detect the presence or absence of a ladder. If the ladder has been placed incorrectly, an alert would be sent, helping the user adjust the ladder before climbing.

In another embodiment, the trigger sensor may be decibel level. A high decibel reading may cause a message to be sent to the user, reminding them to wear earplugs. Similarly, the processor may be used to analyze sound and identify a particular event, such as a fall or explosion, and configured to trigger an action, such as a call to 9-1-1, in the case that a likely accident is identified. It may also be configured to take other actions, such as record a video, or audio, upon these identified events.

Alternative embodiments may allow a sensor device 100 or sensor system 300 to include any combination of pre-defined rules, user-defined rules, pre-defined actions, user-defined actions, and actions based on algorithms. In alternative embodiments, any action may be triggered by any triggering event from any sensor 102. In one embodiment, a sensor device 100 or control center 302 may include auto-updating capability such that it may be updated with newer software or programming without requiring user intervention at the respective device (e.g., without requiring a user to press a button on the respective device to accept the update). In another embodiment, a sensor system 300 includes bulk deployment script to allow easy and quick bulk deployment of the appropriate software and bulk configuration of the appropriate settings across the sensor devices 100 and/or control centers 302. In one embodiment, a control center 302 may send a notification to a sensor device 100 that new settings or rules are available, and the sensor device 100 may pull the new settings or rules from a RESTful API.

In alternative embodiments, sensor devices 100 or sensor systems 300 may be installed in buildings (e.g., commercial, residential, industrial, homes, stores, offices, and factories), in vehicles, and on real property. Sensor devices 100 may be used in conjunction with other monitoring to augment personal detection. For example, BLUETOOTH beacons can sense users coming and going, and detect when an uncertified person has accessed the area. If a worker climbs a cell tower without the application running, or who has been determined to be out of compliance with safety guidelines, an alert may be sent.

In some embodiments, sensor patterns may be identified by the user acting on the user interface of the device. In such embodiments, the user is prompted to respond to a stimulus (i.e. press a button or answer a question). In doing so, the user is identifying an event. Simultaneously, the sensors are recording stimuli. An algorithm can be used to compare the two or more stimuli and find a pattern. For example, the user interface is made to ask a question: “did you just stop the car?” Meanwhile, the accelerometer and GPS are recording data. The user then presses “yes.” The algorithm will then compare the ceased movement of the device (a reduction in accelerometer variability and a reduction in change in latitude and/or longitude). This is an example of “dynamic supervised machine learning.” In this mode, the system can “push” questions or a list of options to the user to request feedback. The list of questions may be pre-programmed or dynamically or randomly generated. Based on the users' response, new questions may appear. Meanwhile, sensor data is captured. Algorithms may be run to compare, correlate or mathematically process the data, linking dynamically-generated prompts, user feedback and association with sensor data, to help computers “learn” about relationships between user inputs and sensor inputs. The data may be communicated visually, verbally or otherwise. In an illustrative example, the device is used to ascertain the relationship between a patient's responses to stimuli (i.e. a question, a series of check boxes or buttons to click on the user interface (i.e. in a health clinic). The user is asked a series of questions (i.e. “did you take your medication, do you feel lethargic, did you eat breakfast today?”). Simultaneously, the accelerometer is measured. The device, in this instance, would be able to correlate user-responses with accelerometer data. If the user indicates through the user interface, verbally, or in other ways that the user feels lethargic, the device may then associate a measured set of accelerometer data with that user response. Once the relationship is proven statistically-significant, which may take several or many associated data sets, the device will be able to prove a mathematically-supported relationship between user lethargy and accelerometer data patterns, thereby enabling the device to later determine the degree of lethargy in the patient based solely on accelerometer data. The device may then recommend certain actions, such as taking a break, taking medications, or avoiding risky behavior such as the operation of heavy machinery. The benefit of this device is that both the user inputs and the sensor data pattern recognition may be dynamic. Thus, the system can be a dynamic supervised generic learning system. This provides many benefits to prior systems, which are typically static on all analogous parts.

In a related embodiment, machine learning algorithms are applied to mathematically correlate sensors and user inputs and dynamically control sensor sensitivity, sensing frequency, and/or the request for user inputs.

In some embodiments, the sensor device 100 or sensor system 300 may modify sensor and communication operations to optimize energy usage (e.g., reduce power consumption, increase battery life) and data usage (e.g., reduce data usage and communication costs, increase data relevance), and to respond to user preferences, where such modification may happen dynamically based on one or a plurality of variables. Such variables may include data from other sensor devices 100 or sensors 102; data from the cloud or Internet (e.g., Internet searches, news posts or articles, or social media activity); other external data (e.g., from external databases); time of day, week, month, or year; weather data; and user control or preferences. Sensor devices 100 may be networked to optimize their performance. Sensor devices 100 and sensor systems 300 may be dynamically controlled by a variety of variables, which may affect triggering events (e.g., trigger conditions) and actions performed. In this and related embodiments, the data generated from user inputs may influence the control of the sensors and/or new inputs. For example, if a user responds to questions in a way that suggests there is a problem, or the device provides accelerometer data (or other sensor data) which is indicative of a problem, the device may speed up sensor readings based on a hierarchically-based evaluation procedure. In this case, the device may be configured to override a concern for energy efficiency because there is a higher-importance desire to capture more data to help evaluate a more critical condition. If, for example, the user is deemed to be lethargic, as assessed by user inputs or sensor inputs or a combination of the two or more variables, the device may intentionally consume more data and energy in an effort to prevent the user from operating machinery while lethargic. The ability for a device to dynamically capture data, the display data and capture of sensor data is critical, unique and beneficial. Further, the ability to mathematically correlate user inputs, sensor data and other external factors is novel and important.

In one embodiment, a sensor device 100 may be used to determine location of a worker. When the weather forecast for that location is dry weather, one risk assessment and insurance rate may be assigned, but if the forecast or actual measured weather is inclement, a different risk assessment may be given. In related embodiment, freezing temperatures measured or forecast may alter the sensing regimen of the device, and the risk rates associated with an activity. The system may further calculate a new rate depending on the weather forecast, giving the user a helpful option, e.g., “if you do the roofing job tomorrow, your insurance rate will be $50 less.”

In another embodiment, a sensor device 100 may include a GPS sensor 102 to sense movement or location and an accelerometer 102 to sense movement. As long as the accelerometer 102 does not detect movement, the sensor device 100 may be programmed to not sense the GPS position and to report it because such data would be the same as the prior data (because the sensor device 100 has not moved) and because sensing, processing, and transmitting such data would be wasteful. In a related embodiment, the GPS sensor can be used to trigger other data gathering functions, such as image capture. A given rule may be to capture a photo upon every stop of a vehicle. Using the GPS and accelerometer to determine the digital signature of a stop, the images may be captured strategically rather than randomly. A rule may be configured to capture a photo every time a truck stops, thus serving as a basis to capture photos of relevant events, such as garbage collections or gas deliveries. In a related embodiment, the accelerometer may trigger a video to be captured. In this case, a high accelerometer reading may cause a video to be captured, which may record a vehicle crash. Capturing video of a crash is helpful in determining its cause. Enabling users to capture multiple streams of associated data (i.e. a stop, a GPS coordinate, a time stamp and a video or photo) enables users to understand the interplay between events and determine, for example, that a propane delivery was made at a particular time and location. Using image recognition technologies, this information may serve to help users in a new way. A garbage hauler, for example, may use the system to identify overfilled garbage cans, associate those photos and their metadata with a GPS coordinate, a given customer and a given service event, and enable the garbage hauler to more accurately bill the customer for services rendered (i.e. a 110% charge for a bin which was over-filled by 10%.) In parallel, the risk associated with an overfilled garbage dumpster may cause the system and method to recalculate the risk-adjusted rate of insurance, because an overfilled bin is inherently more dangerous than a half-full bin.

In one embodiment, a sensor device 100 may use cellular communication for data-light communication and may use WI-FI® communication for data-heavy communication (e.g., photo, video, and audio), or the device/s may store data locally until there is an injury claim. If there is no claim, the data on the device/s may be erased.

In another embodiment, the sensor device is configured to search for Wi-Fi signals in range. The device is configured to capture the unique identification codes of local online devices and upload that data, with a timestamp and GPS coordinate, to the cloud, where it is stored. This data may be later used to assess the number, type or unique identification codes of nearby devices. Thus, it may serve as a data logger for “Mac Addresses.” Such data is useful in determining patterns of visitors carrying communicating devices such as smartphones into work environments, to ensure that there are no unmonitored workers in the work area. The data can be used to assess visitor patterns and anomalies. For example, if an accident occurs, the user may query the database to find out if uncertified workers did tasks that require safety certifications.

In another embodiment, the device is configured to identify other devices and import data. For example, a temperature sensor may be connected via Bluetooth. The device would be configured to “listen” for Bluetooth signals of a certain type and then pair with that device, to upload data. Configuration to pair automatically is critical to easing use for the user, so that pairing is not a process that requires user-intervention. Configuration of this type, it is important that the device configuration searches for a unique identification code, so that security is enhanced. Otherwise, the device may upload malicious code. Thus, the device is configured to pair with other devices only after a unique identification code is accepted by the device.

In another embodiment, the controls for said devices are made available to a user in the form of user-configurable web-based dashboards and sensor and reaction manipulation tools, so that users can configure devices to their liking. The user may configure a customized dashboard showing the sensor data and other data that they deem most valuable. Users may customize a dashboard or several dashboards that show a customized view of information. Similarly, users may manipulate sensors remotely or programmatically, turning on or off sensors, adjusting their sensitivities and sensing frequencies, categorizing sensors as trigger sensors or output actions, such that a customized sensor management system is configurable by the user. The user can adjust timing and sensitivity of each sensor disclosed and may create custom reactions to sensor data and other data as described herein. Further, the user may save these preferences and make available to other users these settings in the form of a Template. Templates may be shared amongst users and bought and sold amongst users and operators of the web-based system. In a related embodiment, a marketplace may be established to facilitate the sharing of sensor and reaction Templates, which govern the choice and hierarchy of sensor use and resultant actions. Users may also input historical data, such as digital signatures, which can be used to compare previously-measured data to sensor data, providing more relevance of the information to the user. In another embodiment, these digital signatures, sensor characteristics and patterns and the like, are stored in a library for use by users, for sharing, for selling, and the like, enabling a crowd-based sensor network that adjusts and improves based on a variety of inputs.

In another embodiment, settings may be adjusted based on trigger mechanisms, for example: sensor settings, sensor hierarchy, triggers and actions can be set by using an NFC tag (Near Field Communication) tag, RFID tag, QR code, written or audible instructions. Upon a trigger, such as a scan of a QR code, or placement of the device near an NFC tag, RFID tag or the like, the device assumes settings and parameters based on pre-configured protocols. For example, if the device is placed next to an NFC tag labeled “Truck,” then placement of the device next to that NFC tag would alter device settings to the appropriate settings for a truck, for example, the device would turn on sensing protocols for GPS, speed, rapid deceleration. If the device is placed next to an NFC tag aside on oil rig, the device would alter sensing protocols for an oil rig, for example, by sensing the cycling of the equipment. Whether by NFC tag, RFID tag, barcode, QR code or other means, and whether the tag is on a truck or oil rig or other asset, the device settings and sensing parameters, hierarchy and the like may be altered based on its placement in a specific environment that benefits from such sensing parameters. In a related embodiment, the device is programmed to sense its own environment and sensed values and automatically switch modes from one sensing regimen to another.

Applying the System to Determine Insurance Rates

As discussed above, the present invention may be embodied in a device, system and method for calculating insurance rates for workers' compensation insurance, life insurance, professional liability insurance or other forms of insurance related to covering a person engaged in activities that have variable associated risk, liability and cost. Today's work environment is more variable than it used to be. Insurance rates today are largely determined by actuarial statistics and by averaging out workers in various levels of risk. However, there is an opportunity to use novel sensor-based quantitative methods to determine risk levels in a dynamic way, which can reduce waste and fraud in insurance provision.

The system is comprised of a plurality of sensors. The sensors may be embedded in a smartphone (e.g., a smartphone including an accelerometer, barometer, gyroscope, microphone, GPS receiver, ambient light sensor, proximity sensor, magnetometer, touchscreen, fingerprint sensor, pedometer, heart rate sensor, thermometer, humidity sensor, Geiger counter, etc.) and/or in other devices, such as a watch, lanyard or safety harness or hard hat.

The sensors detect motions, sounds associated with different types of activities. The system includes a machine learning system so that a library of sensor patterns can be matched to each activity. With each new task logged, the system learns, thus it is a machine learning system and method.

The system also incorporates human inputs, such as the two-way communication of work orders, instructions, schedules, dates, user responses to surveys, and safety training data communication. These inputs are paired with sensor data as a supplement a machine learning-training system to inform the conclusions reached about certain activities.

The system and method are optimized to capture the time and duration of person activities. By capturing the duration of risky activities as a portion of total time elapsed, a ratio can be derived that compares total time to total risky time, thereby enabling a more accurate depiction of overall risk level for the person. For example, if the person does office work for six (6) hours per day, and construction for two (2) hours per day, the ratio of high-risk time to total work time is 2:8, or 25%. Given this rick adjusted ratio, the insurance cost would be lower than if the ratio were 6:8.

When insurance costs are averaged over all people, there is inefficiency in pricing policies, and this leads to inefficient market mechanisms and often fraud. The system can help detect and reduce fraud by tracking actual activities worked, rather than the activities and estimates reported to the regulatory agencies. Today, there is a perverse incentive for workers and employers to lie about actual activities performed. The insurance industry's actuarial/historical based pricing structure averages out the honest and the dishonest people. This is a significant market failure that can be solved by granular sensor-based monitoring systems such as the proposed invention.

The system also allows for data forensics in the case of an accident. This feature can limit liability in the case of an accident and provide valuable learning so that accidents in the future can be avoided.

This innovation enables insurance adjusters to link costs to risks in a more efficient way. The system is thus a sensor-driven measurement system and method of task breakdown to verify split-rates/risk-adjusted rates. In the modern economy, where a person might drive an Uber for a few hours or days per week, then do construction for a few days a week, where schedules are dynamic and ever changing, the advent of an insurance calculation tool and method is a useful and novel approach. For a “gig economy worker,” there is often no coverage, thus, if there is an accident, the worker is either at financial risk or the hirer is at liability risk. By offering insurance per-activity, there is an opportunity to provide a novel and needed insurance program.

Today's workers compensation rates are based on several factors. For example, there is a high degree of variability based on whether a worker is working at ground level or is up on a roof or cell tower. The rates for working at height are significantly higher. Typically, the insurance rate is based on the most dangerous work performed by a person, and there is no adjustment possible to calibrate for the ratio of time that the worker spent “at height” versus on the ground. So, if a person works up on a roof only one hour per day, the rate is the same as if the worker spends 7 hours a day up on a roof. This is a big unnecessary cost for many people.

For example, a worker doing Electrical Component Repair (at the Ground Level), the formula to calculate insurance costs is based on a formula:
Class Code Rate X Experience Mod. X (Payroll/$100)=Premium
Electrical Component Repair (Ground Level), $500,000 Payroll, 1.20 Experience Mod, 30% underwriting credit due to implementation of this process, 1.25 LCM (best case scenario):
2.61×500.0(00)×1.20×0.70×1.25=$13,703
Tower Maintenance/Repair, $500,000 Payroll, 1.20 Experience Mod, 30% UW Credit, 1.25 LCM: 22.51×500.0(00)×1.20×0.70×1.25=$118,178

In accordance with one aspect of the present invention, the sensors are triggered to capture and communicate data relevant to job types. For example, a roofer would be monitored by relevant sensors including accelerometer, gyroscope, barometer, GPS and microphone. The accelerometer and gyroscope are used in tandem to calculate a probability of movement from truck to ladder to rooftop. The microphone can sense the sound of banging a hammer. The barometer determines altitude. GPS can determine location at the job site. Local weather results can influence the risk associated with a given job on a given day. Using the system of sensors and algorithms which are configured to assign a injury probability to each job type, and each job done (eg the time spent up on the roof versus elsewhere, the risk of doing the job when it is raining out, or the conditions are icy, or it is dark at the time of the activity) a risk profile is calculated and a risk-adjusted insurance cost can be calculated. In order for accurate results to be delivered, the system monitors activities in near real-time and compares the risk of those activities at those times to be quantitatively determined by pre-programmed configurations and augmented by a learning system so that the system dynamically responds to historical, actuarial and real-time information. In this sense, it is a dynamic learning system and method.

An important feature is that the system can learn from its users. Simply by connecting the human meaning with the sensor regimen, the user can connect context to sensor patterns. For example, a bouncing motion means walking if the GPS detects forward motion. The same bouncing motion means climbing a ladder if the GPS is stable by altitude is climbing. Using multiple sensors combined with human interpretations is a continuous learning system that increasingly is able to calculate risk and support better quantifications of risk and insurance cost.

The sensors may be calibrated and activated and deactivated based on pre-programmed criteria and/or learning systems. For example, the barometer, to accurately detect the difference between climbing a ladder and riding up an elevator, must be paired with other sensors, human-defined contexts and human inputs using a novel machine learning system. Using a combination of sensors, contexts and algorithms, an accurate determination can be made about the activity and associated risk profile.

Another benefit is that post-accident, there is a sensor-based monitoring method to monitor injuries. For example, before an accident, there is a normal walking gate to a person. This is a pattern and a sensor-identifiable signature. Any deviations from the norm that later occur, such as a limp, are recognizable by comparing the accelerometer, gyroscope, GPS patterns that occur before and after an accident. This can help identify the true timing and consequences of an accident and more accurately match risk to safety to liability.

### CONCLUSION

Numerous embodiments have been described, herein above. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

We claim:

1. A device comprising:
an enclosure case;
a sensor comprising at least one input device, at least one output device, and a communication module;
the sensor configured to sense at least one variable selected from the group consisting of sound, movement, speed, acceleration, proximity, light, location, orientation, magnetic fields, temperature, barometric pressure, and the absence or presence of power;
the sensor configured to sense the at least one variable based on commands received through the at least one input device or the communication module;
the sensor further configured to provide output data corresponding to the at least one variable through the output device or through the communication module.

2. The device of claim 1, wherein the sensor further comprises one or more of the following components for sensing the at least one variable: an accelerometer, a magnetometer, a global positioning system (GPS) sensor, a light meter, a microphone, a camera, a barometer, a thermometer, and a power sensor.

3. The device of claim 1, configured to receive commands for sensing the at least on variable from a central command device, wherein the commands are received through the communication module.

4. The device of claim 1, wherein the device further comprises a processing unit, wherein the processing unit is configured to automatically adjust its processing speed based on sensing requirements.

5. The device of claim 1, wherein the sensor is configured to send the output data in real time at the time of sensing or to send cumulative data for a group of output data at periodic times.

6. The device of claim 1, wherein the output data is stored and erased from the device hierarchically.

7. The device of claim 1, wherein the sensor is configured to sense the at least one variable based on a triggering event.

8. The device of claim 7, wherein the triggering events are defined for the sensor through the input device or through the communication module.

9. The device of claim 8, wherein the sensor is configured to receive triggering event information in the form of a sensor rule, wherein the sensor rules are defined at a central command center and stored in a relational database.

10. The device of claim 9, wherein the triggering event is selected from a group consisting of the one or more of the following: the sensor reaching a threshold measured value, elapse of a threshold amount of time, and external data meeting a preset condition.

11. The device of claim 9, wherein the triggering event is selected from a group consisting of one or more of the following: detecting sound, detecting movement, detecting light or darkness, detecting location, detecting orientation, detecting magnetic fields, detecting presence or absence of connected power, detecting battery level, and detecting Internet search frequency reaching a certain threshold.

12. The device of claim 11, wherein output data for the triggering event is based on sensor thresholds that are compared to digital signatures for the triggering events.

13. The device of claim 12, wherein the sensor is configured to provide output data related to a frequency of the triggering events.

14. The device of claim 1, wherein commands are sent to the sensor through the communication module from a user-configurable web-based dashboard.

15. The device of claim 14, wherein the commands sent to the sensor through the dashboard are in the form of templates having customized rules for controlling the sensor.

16. A method for controlling a sensor, the method comprising:
creating a template comprising rules for controlling the sensor based on triggering events, the triggering events based sensing at least one variable selected from the group consisting of sound, movement, speed, acceleration, proximity, light, location, orientation, magnetic fields, temperature, and the absence or presence of power,
wherein the sensor comprises one or more of the following components for sensing the at least one variable: an accelerometer, a magnetometer, a global positioning system (GPS) sensor, a light meter, a microphone, a camera, a thermometer, and a power sensor;
communicating the template to the sensor through a wireless communication module from a remote dashboard;
executing the template at the sensor;
sensing at least one variable based on the triggering events;
communicating output data corresponding to the sensed at least one variable.

17. The method of claim 16, wherein the sensor communicates the output data in real time at the time of sensing or at periodic intervals.

18. The method of claim 16, wherein the triggering event is selected from a group consisting of the one or more of the following: the sensor reaching a threshold measured value, elapse of a threshold amount of time, and external data meeting a preset condition.

19. The method of claim 18, wherein the triggering event is selected from a group consisting of one or more of the following: detecting sound, detecting movement, detecting light or darkness, detecting location, detecting orientation, detecting magnetic fields, detecting presence or absence of connected power, detecting battery level, and detecting Internet search frequency reaching a certain threshold.

20. The method of claim 19, wherein output data for the triggering event is based on sensor thresholds that are compared to digital signatures for the triggering events.

21. A method for determining a cost of workers' compensation insurance based on monitoring, recording and communicating data representative of work activity characteristics, job assignments and/or timing, whereby the cost is adjustable by relating the job characteristics to predetermined safety standards, comprising:
using a sensor system to monitor a plurality of data elements representative of a task and action of a worker;
accepting user input information from the worker via a user interface of the sensor system; and
calculating risk and/or insurance rates based on dynamic variables determined by the sensor system.

22. A method for proving or disproving certain facts about an incident, such that the system can provide detailed statistics, norms and actual raw data to bolster or refute the claims following an accident or injury.

23. A sensor-based machine learning system that compares group and/or individual activities before and after an accident to produce a quantitative assessment of the injury or aftermath.

24. A method for improving safety by dynamically sensing and communicating safety recommendations in near real time a system that reminds workers to adhere to prescribed safety practices based on a dynamic evaluation of the current environment and activity.
